(19) United States
(12) Patent Application Publication
(10) Pub. No.: US 2017/0015538 A1
(43) Pub. Date: Jan. 19, 2017

(54) Lock Pin Releasing Device for Truck Trailer Axles

(71) Applicant: Blake Alan Fleeman, Coeur D'Alene, ID (US)

(72) Inventor: Blake Alan Fleeman, Coeur D'Alene, ID (US)

(73) Assignee: HB VENTURE GROUP LLC, HAYDEN, ID (US)

(21) Appl. No.: 14/800,100

(22) Filed: Jul. 15, 2015

(51) Int. Cl. B66F 19/00; B25B 27/02

(52) U.S. Cl. CPC B66F 19/00; B25B 27/026

(57) ABSTRACT

Described is a release device for assisting in freeing lock pins that secure truck trailer axles or axle carriages. A gas spring or other form of stored energy is used to provide a lifting or biasing force against a release mechanism or handle associated with the lock pins. A piston and rod or shaft extend out a first end of a cylinder and within an outer cylinder when the device is actuated. A hook or arm is mounted to the outer cylinder or to a hook body affixed to the outer cylinder. A gripping foot is fixed to the second end of the cylinder. The gripping foot is placed against the frame of the trailer when in use. A release mechanism is coordinated with rotation of a knob on the opposite end of the outer cylinder.

### BACKGROUND

Field

The present invention relates to a device to assist in freeing or releasing lock pins that secure tandem axles and axle carriages in position with respect to tractor trailers.

Related Art

In the trucking or freight industry, tandem wheel carriages of trailers are releasably held in position by one or more lock pins. The wheels of the trailer often have to be moved to a different position relative to the trailer to provide a desired amount of support depending on the load distribution in the trailer and other factors.

FIGS. 1-2 illustrate two positions of a set of trailer axles relative to a trailer. With reference to FIG. 1, a tractor unit, tractor or semi 1 is attached to and pulls a semi-trailer or trailer 2. A set of wheels or tandem axles 3 are positioned at the extreme rear of the trailer 2. The front end of the trailer 2 is supported by drive axles 4. A handle or release bar 5 is visible under the middle section of the trailer 2. When the handle 5 is pulled or released, the rear wheel carriage or tandem axles 3 are free to move relative to the trailer 2.

As is well known, in practice, the brakes of the wheels of the tandem axles 3 are set so as to hold the tandem axles 3 fixed relative to the ground, and a driver then uses the power of the tractor unit 1 to move the trailer 2 horizontally relative to the tandem axles 3 to a new location 6. At the new location 6, the front end or drive axles 4 are charged with less of the trailer load. With respect to the lock pins, the driver must exit the tractor unit 1, walk back to the tandem axles 3 to inspect the position of the trailer 2, and then repeat the process iteratively until a desired location of the trailer 2 is reached. Then, the driver re-engages the lock pins.

This process can be very time intensive for several reasons. For example, the lock pins may initially require jostling of the trailer to free the lock pins so that the handle 5 may be manually operated. Thus, a driver may need to use the truck unit 1 just to free the lock pins before being able to pull or release the handle 5, and only afterward then being able turn to the task of moving the tandem axles 3. At this point, after having initially released the handle 5 and lock pins, the driver must get into the truck unit 1 to move the trailer 2 relative to the tandem axle 3. Since the driver generally cannot see or detect with sufficient accuracy from the cabin of the tractor unit 1 whether the lock pins are properly aligned with any hole or with a desired hole in the frame, the driver must repeatedly and iteratively inspect at close range the position of the lock pins relative to the frame holes along the bottom of the trailer 2 before being able to reengage the lock pins. Some attempts have been made to ease the nature of these tasks. However, none have been extremely useful in reducing the time spent in moving tandem axles 3 relative to trailers 2.

FIG. 3 is a perspective cut-away view of a portion of a trailer such as one shown in FIGS. 1-2. FIG. 3 illustrates a typical configuration or geometry of the various components involved in pulling lock pins. With reference to FIG. 3, the trailer 2 rides on rails 7 above the tandem axles 3. The rails 7 slide horizontally on the carriage 8 of the tandem axles 3. Brackets 9 mounted to the carriage 8 keep the rails 7 aligned and releasably connected with the tandem axles 3. A handle 5 or actuator releases and engages lock pins 10 into apertures or holes 11 in the rails 7. Ordinarily, the release mechanism is spring loaded which forces the lock pins 10 into position. The handle 5 may be released by pulling the handle 5 outward through the aperture 12. The handle 5 and lock pin 10 are shown in a released state in FIG. 3 since the pin 10 is disengaged from the apertures 11 of the rail 7.

### SUMMARY

There has been a significant need to reduce the time spent adjusting tandem axles of truck-trailers. Further, there has been a need for a device to physically assist the occasionally arduous task of freeing jammed lock pins of trailers. There is still a further need for a device to reduce the amount of time a driver spends under a trailer checking for proper position of lock pins relative to trailers.

In order to meet these and other needs, described herein is a biasing device that provides a force for working with tandem wheels or axles of a truck trailer. According to an illustrated embodiment, a first cylinder includes a longitudinal axis, a first end and an opposing second end. A piston is slidably mounted in the first cylinder to divide the first cylinder into a first chamber and a second chamber on opposite sides of the piston. A shaft is secured to the piston and extends through the first chamber and out of the first end of the first cylinder. A biasing element is present in the second chamber of the first cylinder between the second end of the first cylinder and the piston, the biasing element biasing the piston and shaft into an extended position. A foot is mounted to the second end of the cylinder. A second cylinder is mounted concentric to the first cylinder. A release mechanism is proximate to the first end of the second cylinder and is designed to release the biasing mechanism when the biasing mechanism is in the retracted position and when the device is positioned properly relative to the frame of a trailer and a handle for releasing lock pins of the trailer. One or more engaging arms are mounted to the second cylinder proximate to the second end of the second cylinder.

In some embodiments, the shaft may include a distal end. In some embodiments, the piston and shaft are movable between a retracted position in which at least a portion of the shaft is within the first cylinder, and an extended position in which a portion of the shaft is extended out of the first cylinder.

In some embodiments, the foot may include a dedicated region for bearing against a surface.

In some embodiments, the second cylinder may include a first end proximate to the first end of the first cylinder and distal end of the shaft.

In some embodiments, the second cylinder may further include a second end proximate to the second end of the first cylinder.

In some embodiments, the second cylinder may include a longitudinal axis substantially parallel to the longitudinal axis of the first cylinder.

In some embodiments, the engaging arm projects outwardly from the second cylinder in a generally radial direction transverse to the longitudinal axis of the second cylinder, the engaging arm configured for releasably engaging with a portion of a lock pin mechanism, whereby, when the biasing element is freed, the biasing device provides a biasing force to the lock pin mechanism to facilitate release of a lock pin from its place of engagement, the first cylinder extending exteriorly from the first end of the second cylinder as the biasing element extends the shaft from the first cylinder within the interior of the first end of the second cylinder.

In some embodiments, the dedicated region may include a gripping feature to facilitate contact between the surface and the foot.

In some embodiments, the engaging arm is contoured to accommodate a curved surface of the lock pin mechanism so as to facilitate the biasing device remaining in place while an operator moves the truck trailer.

In some embodiments, the biasing element may include a compressed gas. In some embodiments, the device may further include a pliant and insulating gripping material mated to an outer surface of the second cylinder end along a length of the second cylinder sufficient for at least one hand of a user.

This summary is not intended to identify key or critical aspects of the invention. Additional features and advantages of the disclosure are set forth in the detailed description which follows.

### BRIEF DESCRIPTION OF THE DRAWINGS

While the appended claims set forth the features of the invention with particularity, the invention, together with its objects and advantages, is more readily appreciated from the following detailed description, taken in conjunction with the accompanying drawings. Throughout, like numerals generally refer to like parts. Unless specifically indicated, the components and drawings are not shown to scale.

FIGS. 1-2 illustrate two positions of a set of trailer axles relative to a truck trailer.

FIG. 3 is a perspective cut-away view of a portion of a trailer such as one shown in FIGS. 1-2.

FIG. 4 is a perspective view of one implementation of the device for providing a biasing force, the device being in a fully retracted or compressed configuration.

FIG. 5 is a perspective view of a portion of a trailer such as one shown in FIGS. 1-2 with a device in a retracted configuration and positioned proximate to and engaged with a handle for releasing lock pins.

FIG. 6 is a perspective view of the portion of the trailer shown in FIG. 5 with the device in a partially extended configuration after having placed the handle in a released position.

FIG. 7 is a perspective view of the device of FIG. 4 in a fully extended or released configuration.

FIG. 8 is a perspective exploded view of the components of the device first shown in FIG. 4.

FIG. 9 is a perspective view of the cylinder and shaft of the biasing device shown in FIG. 8.

FIG. 10 is a perspective view of an extension element according to a second embodiment.

FIG. 11 is a lateral view of a foot member according to a second embodiment.

### DETAILED DESCRIPTION

As described in the background, there has been a substantial and unmet need for a tool to assist with disengaging lock pins and moving tandem axles relative to trailers in the freight industry. The present invention shown in FIG. was designed to fill such need.

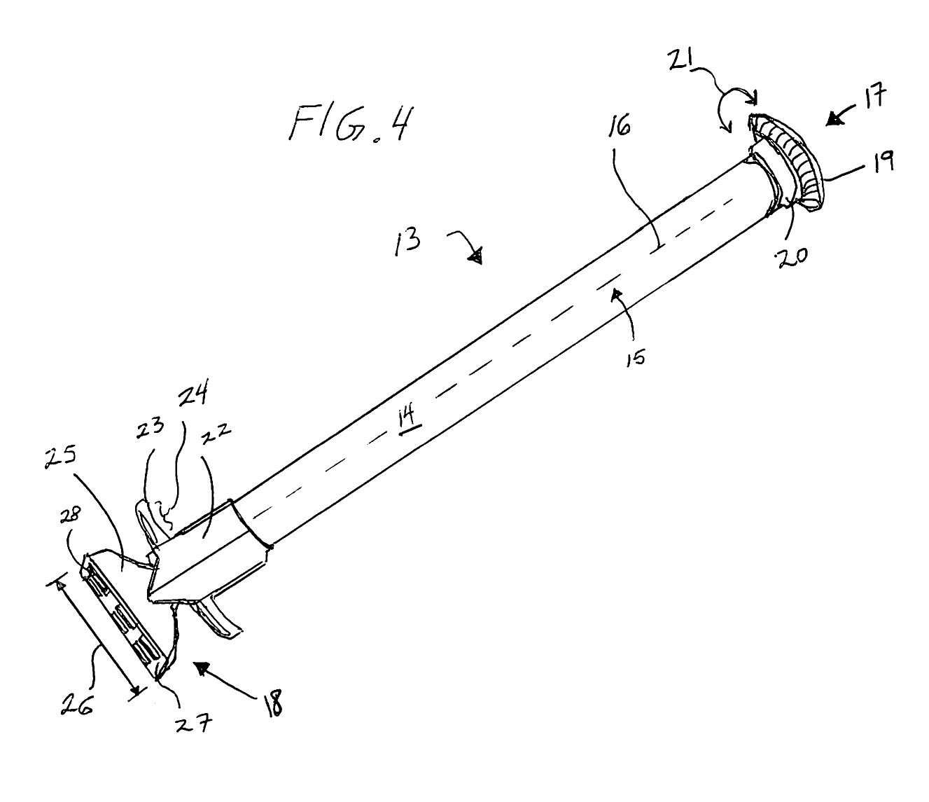

FIG. 4 is a perspective view of one implementation of a device for providing a biasing force such as against a lever or handle 5. With reference to FIG. 4, the biasing device 13 is in a fully retracted or compressed configuration. The device 13 includes a central tubular or cylindrical body 14 having an outer surface 15 and an axis 16 running through its center. The device 13 and cylinder 14 have a first end 17 and a second end 18. Affixed to the first end 17 is a knob 19 which includes a connecting neck 20 that is mounted to the lock bone 44. The knob 19 may be turned relative to the cylinder 14 along a rotational range of motion 21.

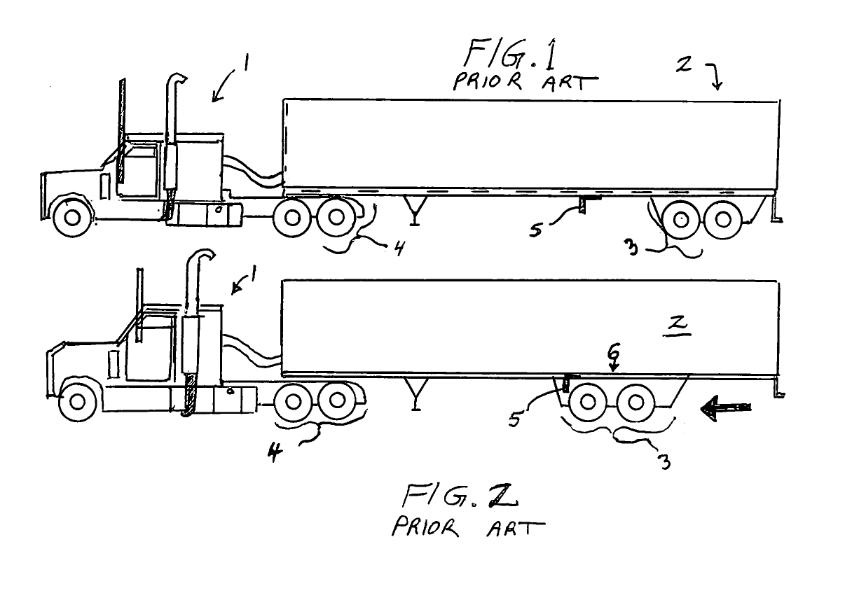

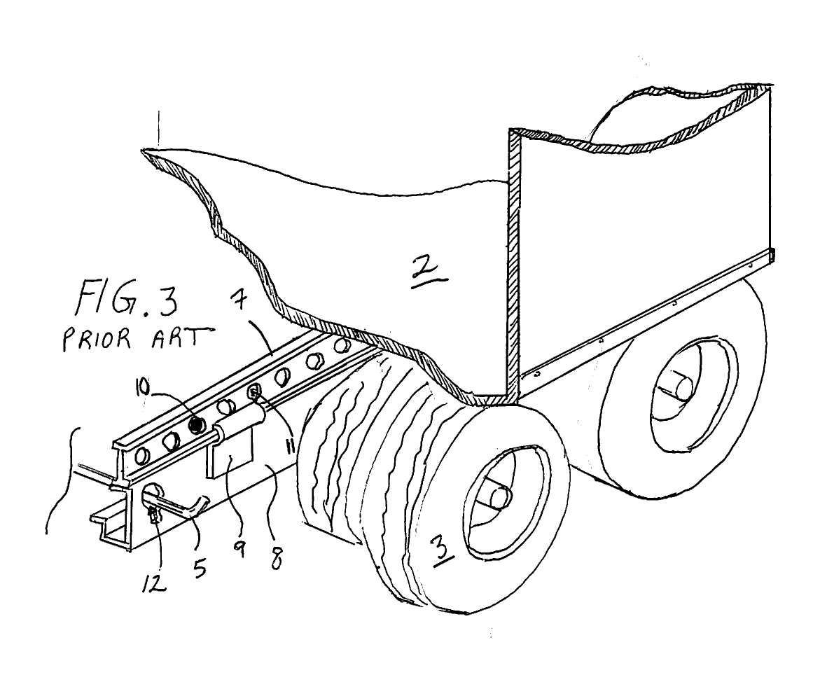

Mounted to the opposing second end 18 of the cylinder 14 is a hook body 22 having one or more hooks 23 protruding substantially radially from the axis 16 of the cylinder 14. Each hook 23 includes an engagement region 24 that preferably includes a curved surface to encourage sustained engagement with a pin-disengaging handle. The hooks 23 and hook body 22 are preferably made of metal so as to provide sufficient strength to engage with and manipulate a pin-disengaging handle (shown as handle 5 in FIGS. 1-3) under substantial resistive forces as are common in large commercial machinery such as semi-trailers. The hook body 22 and hooks 23 may be made as a single part so as to encourage economy of manufacture.

As shown in FIG. 4, a foot 25 is mounted at the opposing second end 18 to a component within the outer cylinder 14, not to the outer cylinder. The foot 25 is formed so as to include a substantially planar and rectangular footprint along a transversal axis 26. The transversal axis 26 lies in a plane that is substantially perpendicular to the axis 16 of the cylinder 14 The hooks 23 may be aligned with the transversal axis 26 and foot 25 to encourage an efficient and protracted application of mechanical force to the handle 5 when the device 13 is engaged into proper location (described further herein in more detail). The width of the foot 25 is of arbitrary size but is preferably about the same size as the diameter of the cylindrical body 14 of the device 13. The bottom surface 27 of the foot 25 may include gripping features 28 such as grooves, teeth or spikes, or may be rubber-like feet affixed by glue, adhesive or other means. Other sizes, shapes and geometries of foot 25 may be made that perform substantially the same as the device 13 shown in FIG. 4 according to further experimentation.

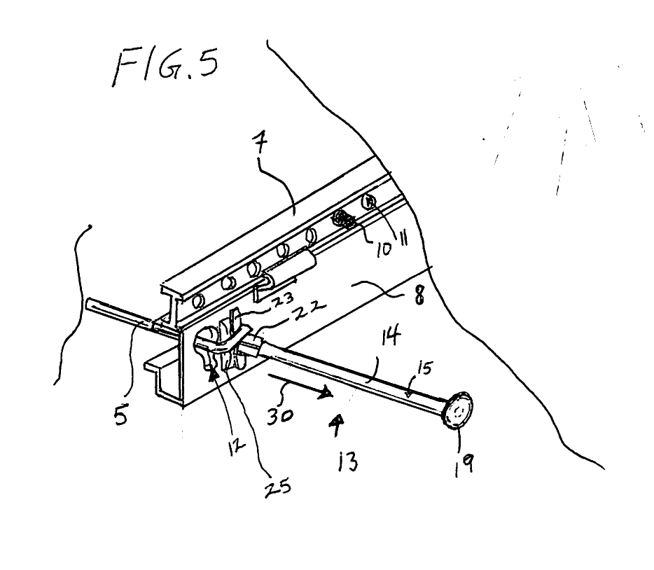

FIG. 5 is a perspective view of a portion of a trailer such as one shown in FIGS. 1-2 with a device 13 in a substantially retracted configuration and positioned proximate to and engaged with a handle 5 for releasing lock pins 10. That is, the device 13 has not yet been triggered and used. A user installs the untriggered device 13 when the pins 10 are engaged through the apertures 11 formed in the rail 7. The handle 5 provides mechanical connection with the pins 10; the handle 5 passes through an aperture 12 in the frame or carriage 8.

With reference to FIG. 5, a biasing device 13 is installed normal or perpendicular to the surface of the carriage 8 such that the foot 25 is placed flush against the carriage 8. The hook body 22 is installed under the handle 5 such that the hook 23 is engaged with a portion of the handle 5. The combined height of the foot 25 and hook 23 is preferably smaller than the space between the handle 5 and the carriage 8 when the device 13 is initially placed against the carriage 8. The device 13 is preferably installed by placing the foot 25 against the carriage 8 and then, through a twist of the entire device 13, one of the hooks 23 is placed under the handle 5.

Then, in order to apply a biasing force to the handle 5, the knob 19 is turned so as to activate or release the biasing force from the device 13 (e.g., via a gas spring or mechanical spring within the device 13). When initially applied, the biasing force closes any gap between the handle 5 and the hook 23 as the body of the device 13 quickly extends upward against the handle 5 under the influence of the biasing force. The biasing force acts along a motion vector 30 that is consistent with the axis of the range of motion of the handle 5. Preferably, the biasing force is substantial such that the device applies between approximately 40 and 80 lbs of force to the handle 5. The device 13 may be configured or assembled with components to be able to apply more or less force than the preferable range of 40 to 80 lbs of force.

The application of the biasing force causes the hooks 23 to extend relative to the stationary foot 25 that is pressed against the carriage 8. Instead of pulling the handle 5 by hand, a user may use the biasing device 13 to apply the necessary force lateral and perpendicular to the carriage 8. The handle 5 stops when it reaches the end of its inherent range of motion. That is, it is preferable that the range of travel of the foot 25 relative to the rest of the device 13 is greater than the range of motion of a handle 5 for most types of trailers 2. Accordingly, the force applied by the device 13 keeps the device 13 suspended or pressed in place between the handle 5 and carriage 8 when in use. Preferably, when the user installs the device 13, and the handle 5 moves to a released position (and the pins 10 are thereby released), the device 13 remains forcefully engaged and suspended between the handle 5 and carriage 8 until forcefully removed. The end or knob 19 protrudes beyond the side of the trailer 2 so that the user may be able to visually determine when the device 13 has been actuated.

During use of the device 13, the driver may need to return to the cabin of the truck (not shown) and may need to engage the engine of the truck to jostle or otherwise release some of the bind or frictional resistance between the rail 7 and pins 10. Such jostling may be necessary to reduce an amount of force required to move the handle 5 solely by the device 13. That is, an initial installation of the device 13 onto the handle 5 may not immediately actuate or move the handle 5. In such circumstance, the user may be required to reduce binding in the lock pins 10. Alternatively, the user may opt to pull on the device 13 by gripping the outer surface 15 and pulling on the cylinder 14 to apply additional force to the handle 5 beyond the force applied by the device itself. In such circumstance, the device 13 substantially aids the user in applying a force necessary to free the handle 5 from its engaged position. The device 13 is constructed of strong materials so as to be sufficiently rugged to withstand forces substantially greater than those applied by the biasing force provided from within the device 13.

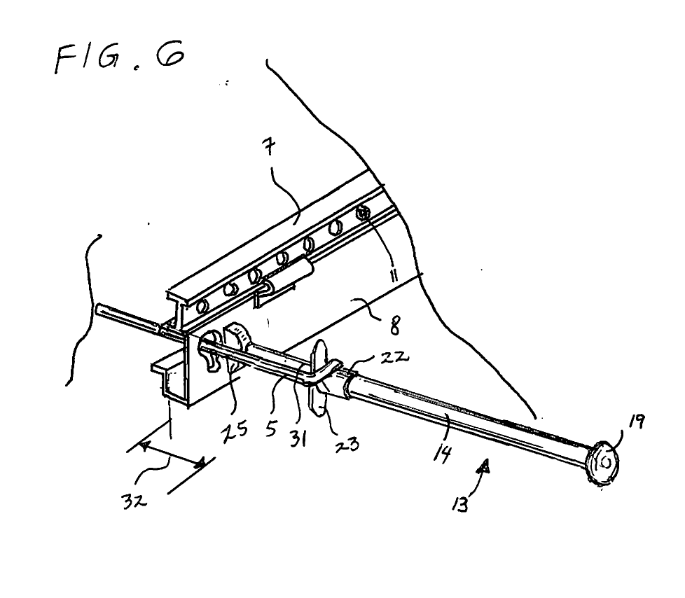

FIG. 6 is a perspective view of the portion of the trailer shown in FIG. 5 with the device 13 in a substantially extended configuration after having placed the handle 5 in a released position. With reference to FIG. 6, the handle 5 has reached its fully extended position by being moved by the device 13 a certain distance 32. The lock pins (not shown) have been removed from the apertures 11 in the rail or beam 7. In contrast, the device 13 has not yet reached the end of its range of motion; that is, the device is not fully extended and still maintains itself lodged between the handle 5 and the carriage 8. Accordingly, the foot 25 remains firmly pressed against the carriage 8 by an inner cylinder 31. According to one illustrative embodiment, the inner cylinder 31 is part of a gas spring. The gas spring provides the biasing force. In FIG. 6, the cylinder 31 and foot 25 still has more range of travel and may be further extended beyond the distance traveled 32 by the handle 5. The hook body 22 remains under and proximate to the handle 5 and one of the hooks 23 remains engaged with the handle 5. To be released, a user would grasp the cylinder body 14 and would twist the device 13 clockwise so as to free the hook 23 from the handle 5. Internally, the cylinder body 14 is free to rotate relative to the inner cylinder 31 such that the foot 25 remains stationary relative to, and pressed against, the carriage. Without anything to press against, the inner cylinder 31 would then be free to extend to the limit of its range of motion as the device 13 is pulled from the vicinity of the handle 5. Preferably, the knob 19 and a portion of the device 13 (e.g., cylinder 14) extend outside the profile of the trailer 2 so that a driver in the cab of the truck would be able to see the knob 19 and cylinder 14 when in the partial extended position. That is, the driver would be able to see the knob 19 and cylinder after the lock pins have been popped loose from their apertures. The driver would then be aware of the freedom of the trailer 2 relative to the carriage 8, and the driver could then move the location of the tandem axles relative to the trailer 2. The driver would then manually re-engage the lock pins before driving away with the trailer attached to the truck unit.

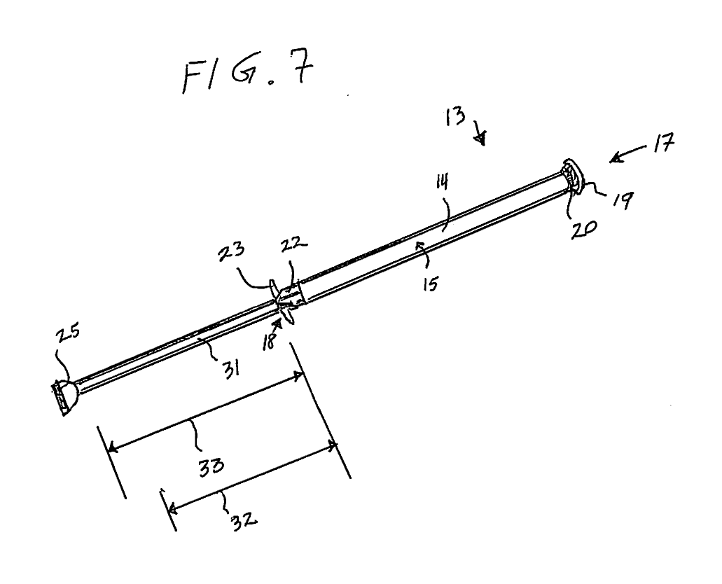

FIG. 7 is a perspective view of the device of FIG. 4 in a fully extended or released configuration. With reference to FIG. 7, the device 13 includes a principal or outer cylinder 14 with an outer surface 15. On a first end 17, a knob 19 is installed via its attachment collar or connecting neck 20 to the lock bone or extension (not shown; interior to outer cylinder 14). A hook body 22 is mounted on the second end 18 of the cylinder 14. The hook body 22 includes one or more hooks 23 such as two opposing hooks 23 that extend radially outward from the cylinder 14. An inner cylinder 31 such as of a gas spring extends out of the second end 18 of the device 13 and across and up to a maximal range 33 that is preferably in excess of a maximum range 32 of the operation of a lock pin handle (not shown in FIG. 7; shown in FIG. 5, element 5). A foot 25 is attached to a free end of the inner cylinder 31.

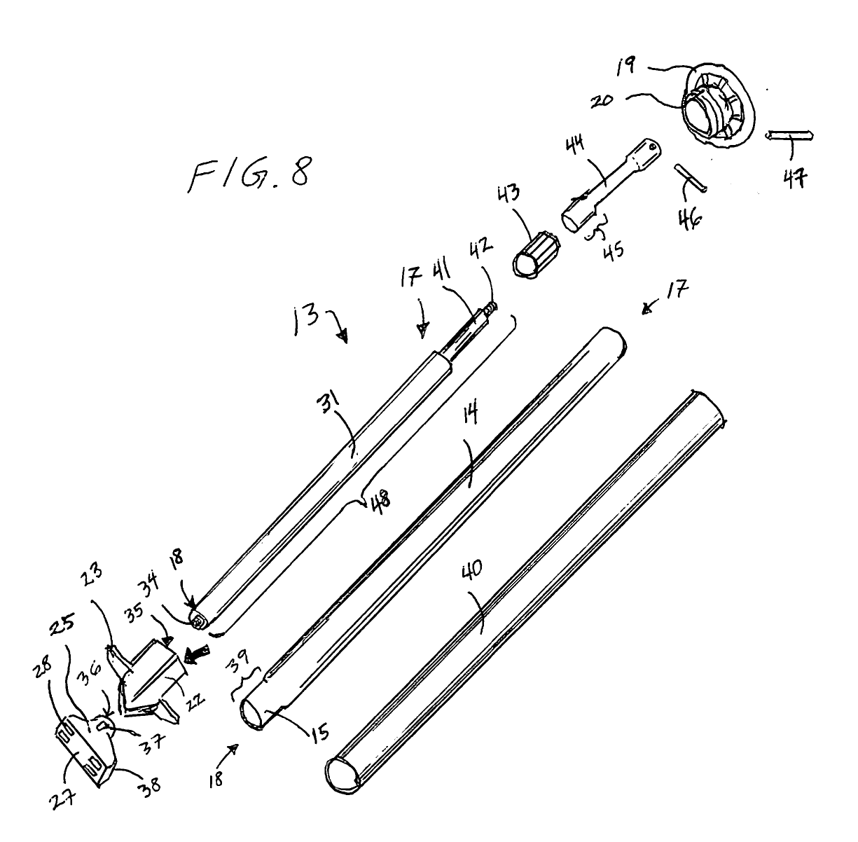

FIG. 8 is a perspective exploded view of the components of the device 13 first shown in FIG. 4. With reference to FIG. 8, the device 13 includes a biasing-inducing member that can provide a biasing force. For example, the bias force member may be a compressed gas spring 50. A compressed gas spring 50 includes an inner cylinder 31 and a shaft 41. The shaft 41 is preferably made of a metal such as a stainless steel, a non-stainless steel or an aluminum so as to be sufficiently strong so that the device 15 may provide a substantial biasing force.

The first end of the shaft 41 may include a threaded bolt 42 so as to threadably connect or mount to another component such as to or inside an extension 44. One or both ends 45, 60 of the extension 44 may be fluted or enlarged. A first end 45 may be fluted or enlarged so as to fit over or accommodate a diameter of the shaft 41 and to provide sufficient mechanical strength to the device 13 while at the same time reducing the overall weight of the device 13. The distal end 60 may be enlarged so as to engage properly with a neck portion 20 of the handle 19. Alternatively, the extension 44 may be of uniform diameter and may be of a same, smaller or larger diameter than the shaft 41. The extension 44 may be solid or hollow and may be made of a same, similar or different material than the shaft 41.

A first pin 46 and a second pin 47 provide a locking functionality to the device 13. During assembly, a first pin 46 is inserted through a pair of slots 48 in the distal end 60 of the extension 44 and into a pair of corresponding apertures 53 in the cylinder 14. The extension 44 is held in place laterally inside the cylinder 14 by the first pin 46. The first pin 46 lies across a diameter of the hollow cylinder 14.

The second pin 47 is inserted into a pair of apertures 51 in the handle 19 and through a pair of apertures 49 in the extension 44. The second pin 47 mechanically ties the handle 19 to the extension 44. A leading edge or surface 52 of the handle 19 is preferably physically abutted to an end surface 54 of the cylinder 14 by selective placement of the apertures 49, 51 and pair of slots 48 in the respective components. The cylinder 14 and first pin 46 remain stationary in relation to the handle 19; the handle 19 can be rotated relative to the cylinder 14 and gas spring 50. The slot 48 provides a range of rotating motion to the extension 44, handle 19 and cylinder 14.

On or over a first end or distal end 17 of the gas spring 50 may be threaded or assembled a bushing 43. A pair of arms 55 on the proximal side of the extension 44 lock the shaft 41 into a fixed position relative to the inner cylinder 31 of the gas cylinder 50. The arms 55 lock into features of a bushing 43 as described and illustrated further herein. Among possible functions, the bushing 43 provides a secure fit for the outer cylinder body or cylinder 14 relative to the inner cylinder 31. A tubular grip 40 or grip material may be glued, sprayed, wrapped or formed onto the outer surface 15 of the cylinder 14. Preferably, the outer grip 40 is made of a rubber-like or foam-like material so as to provide a non-heat-conductive experience for a user who grasps the device 13. The outer grip 40 is designed for all types of weather including extreme heat and cold. The grip 40 provides a more secure surface for handling the device 13 as compared to a smooth metal surface or smooth plastic surface 15 of the cylinder 14.

The second end or proximal end 18 of the cylinder 14 may include a fluted or tapered region 39 so that the cylinder 14 properly and tightly fits into the opening 35 of the hook body 22. The hook body 22 is formed with or includes one or more hooks 23 that extend from the hook body 22. The second end or proximal end 18 of the inner cylinder 31 may include a threaded post 34 so as to thread into a corresponding and unillustrated female receiver inside the receptacle or hollow 35 of the hook body 22 to provide extra strength to the connection between the inner cylinder 31 and the hook body 22. The proximal end of the hook body 22 is securely mounted to the foot 25. The foot 25 includes gripping features 28 such as grooves or teeth, or may be rubber-like feet affixed by glue, adhesive or other means. The bottom surface 27 of the foot 25 is preferably flat so as to provide an engaging surface against a portion of an axle carriage (not shown) when the device 13 is assembled and placed in service. The foot 25 may be contoured to include rounded shoulders 38 and, at the distal end 36, the foot 25 is tapered and shaped so as to engage and be fastened to the hook body 22. The foot 25 may include a mechanical fastener or divot 37 to more securely engage with the hook body 22, and particularly to engage with a tapered portion of the hook body 22. The divot 37 prevents the foot 25 and cylinder 31 from rotating relative to the extension 44 its arms 55.

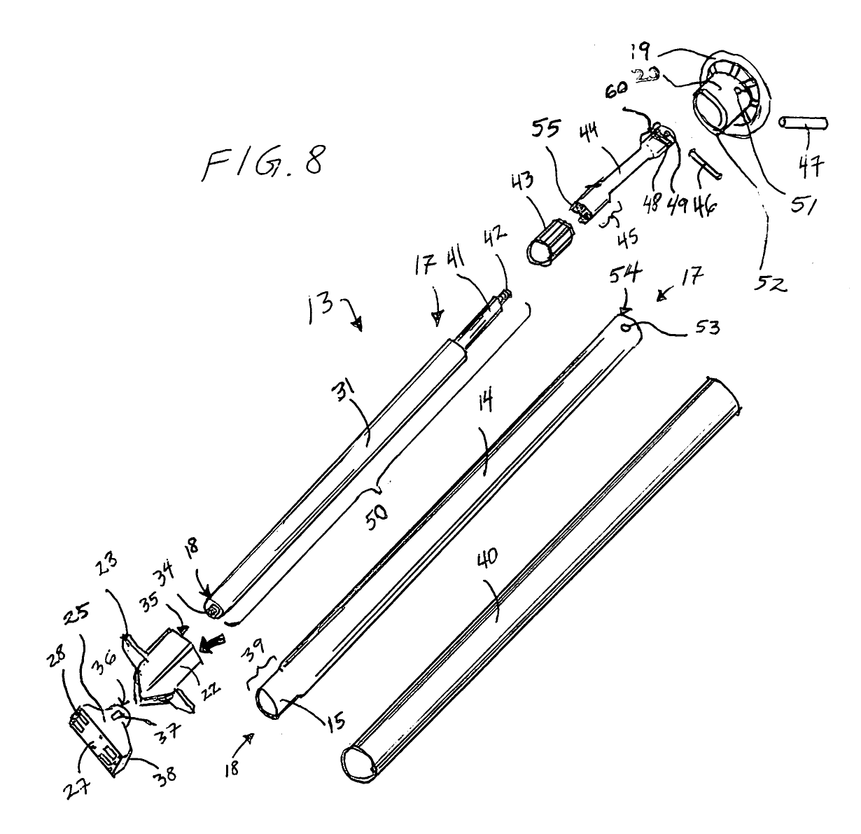

FIG. 9 is a perspective view of the cylinder 31 and shaft 41 of the biasing device shown in FIG. 8. With reference to FIG. 9, on the distal end 17 of the cylinder 31 is affixed a bushing 43. The bushing 43 is preferably made of metal. The bushing 43 includes one or more channels 59 machined out of the bushing 43. The channel 59 allows air to pass from one side of the bushing 43 to the other when the bushing 43 and other components are assembled inside the outer cylinder 14 (not shown in FIG. 9 for sake of simplicity). Yet further, 59 the channel 59 serves as a guide to line up the bushing 43 with a pointed portion of the hook body 22 during assembly. The bushing 43 and hook body 22 are fixedly attached during assembly and features of the same must coordinate with each other as further described herein.

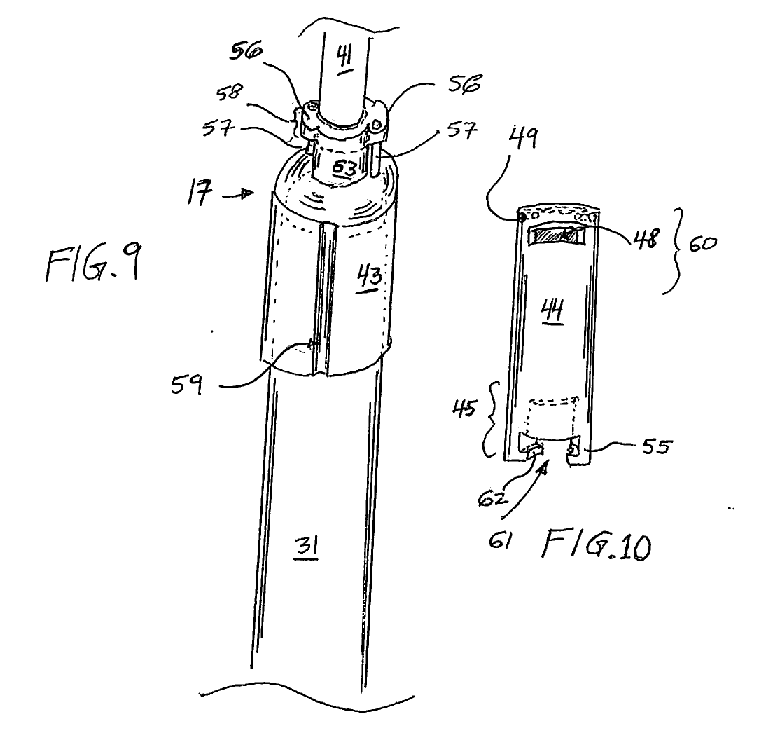

A pair of edges, lips or locking flanges 56 protrude laterally from the distal end of the neck 63. The flanges 56 do not circumnavigate the circumference of the neck 63. Instead, the flanges 56 run along a portion of the neck 63 and oppose each other. The flanges 56 are a thickness 58 tall. The flanges 56 provide a surface to bias against when the force of the gas cylinder is active. The flanges 56 thereby hold the shaft 41 stationary when properly engaged with arms or other element of the extension 44 or other component affixed to the end of the shaft 41 as described further in relation to FIG. 10.

The shaft 41 of the gas spring 50 passes and slidably operates through the neck 63. The flanges 56 are each machined or formed with apertures for receiving vertical pins 57. One or more of the pins 57 serve as an end of rotatable motion when the handle 19 and extension 44 (not shown) are rotated relative to the bushing 43. While only one pin 57 is required to prevent rotatable motion, two pins 57 are provided for security, safety and redundancy in the embodiment shown.

FIG. 10 is a perspective view of an extension element according to a second embodiment. With reference to FIG. 10, a first end 45 of the extension 44 includes a pair of arms 55. Along each end of the arms 55 is machined a ledge or lip 62 for engaging with the flanges 56 shown in FIG. 9. The distal end of the shaft 41 engages in the recess 61 machined in the proximal or first end 45 of the extension. At the distal end 60 of the extension, a slot 48 is visible. The slot 48 is preferably one of a pair of slots 48 that provides a passage laterally through the extension for a securing pin 46 (see FIG. 8). The distal end 60 also includes a pair of apertures 49 for receiving a pin (not shown in FIG. 10). Such pin is described in relation to FIG. 8. The extension 44 is shown with a uniform outer diameter and of a size larger than the shaft 41 of FIG. 9 but of small enough diameter to fit inside an outer cylinder 14.

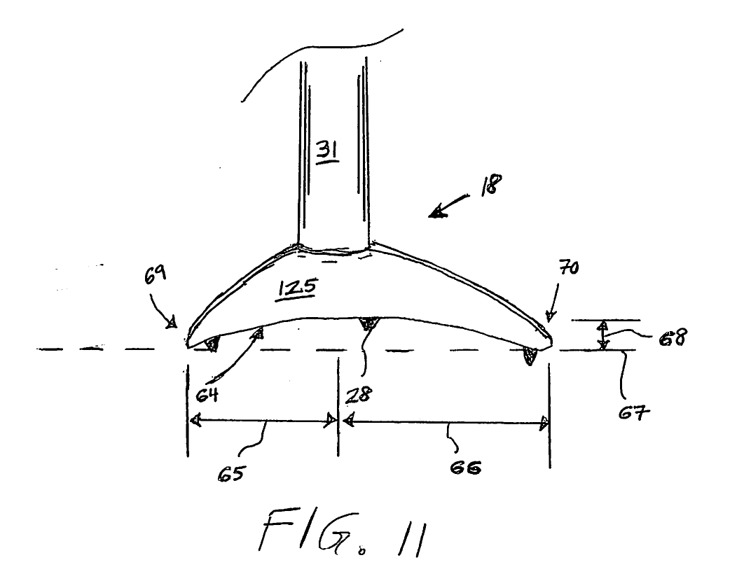

FIG. 11 is a lateral view of a foot member according to a second embodiment. A first embodiment of a foot 25 is illustrated and described in relation to FIG. 4 and FIG. 8. With reference to FIG. 11, a foot 125 is mounted to a proximate or second end 18 of the cylinder 31 or a biasing component. The foot 125 includes a first end 69 and a second end 70. A distance 65 to the first end 69 from a median axis through the center of the cylinder 31 is shorter than a distance 66 to the second end 70 from the median axis. Accordingly, a user has the opportunity to place either the first end 69 or the second end 70 under a pin release handle when in use. Depending on the geometry of the same, by having ends 69, 70 protruding to different lengths, a user may find that a first end 69 or a second end 70 functions better than the other to pull a pin release handle. The foot 125 also includes a working surface or bottom surface 64 that is concave or curved relative to a flat or horizontal reference line 67. The curvature of the surface 64 is accentuated for purpose of illustration only. A typical curvature of the bottom surface 64 is preferably two to three millimeters of distance 68 to an apex of the curved bottom surface 64 as measured from a horizontal line or plane 67. While a single dimension of curvature is shown, curvature in the bottom surface 64 can also be in two dimensions so as to form a a cup-like surface. The surface 64 may be parabolic or may vary in curvature according to a circular trajectory. Further, as shown, a set of three teeth 28 are visible approximately mounted along a front edge of the foot 125 with another set of three gripping features or teeth implied but not visible due to the limitations of the side view illustrated. The foot 125 and gripping features 28 are preferably made of metal so as to endure the substantial forces inherent in the operation of pin pulling.

Conclusion. A few examples and embodiments of the innovative technology are described above and illustrated in the drawings. It will be apparent to one skilled in the art that the described technology can be practiced without these specific details. Further, it is not possible to describe every combination of components or methodologies for purposes of describing the subject innovation. However, one of ordinary skill in the art should recognize that many further combinations and permutations of the innovation are possible. Accordingly, the innovation is intended to embrace all such alterations, modifications and variations that fall within the spirit and scope of the description and appended claims. In certain instances, structures, devices, systems and methods are shown only in block diagram or simplified form in order to avoid obscuring the description.

The term “includes” as used herein is intended to be inclusive in a manner similar to the term “comprising.” Reference to “one embodiment”, “an embodiment”, or “implementation” means that a particular feature, structure, or characteristic described in connection with the embodiment or implementation is included in at least one embodiment or implementation. Appearances of the phrase “in one embodiment” in various places are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. Various modification and changes can be made to the illustrated embodiments and description without departing from the broader spirit of the contents of the description. In this technology, advancements are frequent and further advancements are not easily foreseen. The disclosed embodiments may be readily modifiable in arrangement and detail as facilitated by enabling technological advancements without departing from the principles of the present disclosure.

I claim:

1. A lock pin release device for assisting release of a trailer lock pin, the device comprising:
a biasing mechanism including (1) a cylinder having a longitudinal axis, a first end and an opposing second end; (2) a piston slidably mounted in the cylinder to divide the cylinder into a first chamber and a second chamber on opposite sides of the piston; and (3) a shaft secured to the piston and extending through the first chamber and out of the first end of the cylinder, the shaft having an outer free end;
wherein the piston and shaft are movable between a retracted position in which at least a portion of the shaft is within the cylinder, and an extended position in which a portion of the shaft is extended out of the cylinder;
a biasing means in the second chamber of the cylinder between the second end of the cylinder and the piston, the biasing means biasing the piston and shaft into the extended position;
a foot mounted to the second end of the cylinder of the biasing mechanism, wherein the foot includes a flat face for bearing against a portion of a frame adjacent to the lock pin;
a pipe mounted concentric to the biasing mechanism, and wherein the pipe includes a first end proximate to the first end of the cylinder and distal end of the shaft, and wherein the pipe further includes a second end proximate to the second end of the cylinder, and wherein the pipe includes a longitudinal axis substantially parallel to the longitudinal axis of the biasing mechanism;
a release mechanism proximate to the first end of the pipe for releasing the biasing mechanism when the biasing mechanism is in the retracted position; and
an engaging member mounted to the pipe proximate to the second end of the pipe, and wherein the engaging member projects outwardly from the pipe in a generally radial direction transverse to the longitudinal axis of the pipe, the engaging member configured for releasably engaging with a portion of a lock pin mechanism, whereby, when the biasing mechanism is released, the device provides a biasing force to the lock pin mechanism to facilitate release of the lock pin from the frame, the cylinder extending exteriorly from the first end of the pipe as the biasing mechanism extends the shaft from the cylinder within the interior of the first end of the pipe.

2. The device of claim 1, and wherein the biasing mechanism includes a compressed gas.

3. The device of claim 1, and wherein the biasing mechanism includes a spring.

4. The device of claim 1, and wherein the device further comprises an extension mounted to the free end of the shaft, and wherein the extension is also mounted to the pipe with a pin.

5. The device of claim 4, and wherein the device further comprises a handle mounted proximate to or at the first end of the pipe, and wherein the release mechanism includes a release member actuated by rotating the handle, and wherein the extension extends to and abuts the handle.

6. The device of claim 5, and wherein the handle includes a visual indicator that extends coaxially with the pipe and outwardly from the second end of the pipe when the shaft extends a minimum distance from the retracted position.

7. The device of claim 5, and wherein device further comprises a sleeve mounted to the first end of the cylinder, the sleeve shaped and configured to act as a bushing between an exterior surface of the cylinder and the first end of the pipe.

8. The device of claim 5, and wherein the device further comprises a gripping material mated to an outer surface of the pipe and extending substantially from the first end of the pipe to the second end of the pipe.

9. A biasing device for providing a biasing force for working with tandem wheel positioning relative to a truck trailer, the device comprising:
a first cylinder having a longitudinal axis, a first end and an opposing second end;
a piston slidably mounted in the first cylinder to divide the first cylinder into a first chamber and a second chamber on opposite sides of the piston;
a shaft secured to the piston and extending through the first chamber and out of the first end of the first cylinder, the shaft having a distal end, and wherein the piston and shaft are movable between a retracted position in which at least a portion of the shaft is within the first cylinder, and an extended position in which a portion of the shaft is extended out of the first cylinder;
a biasing element in the second chamber of the first cylinder between the second end of the first cylinder and the piston, the biasing element biasing the piston and shaft into the extended position;
a foot mounted to the second end of the cylinder, wherein the foot includes a dedicated region for bearing against a surface;
a second cylinder mounted concentric to the first cylinder, and wherein the second cylinder includes a first end proximate to the first end of the first cylinder and distal end of the shaft, and wherein the second cylinder further includes a second end proximate to the second end of the first cylinder, and wherein the second cylinder includes a longitudinal axis substantially parallel to the longitudinal axis of the first cylinder;
a release mechanism proximate to the first end of the second cylinder for releasing the biasing mechanism when the biasing mechanism is in the retracted position;
an engaging arm mounted to the second cylinder proximate to the second end of the second cylinder, and wherein the engaging arm projects outwardly from the second cylinder in a generally radial direction transverse to the longitudinal axis of the second cylinder, the engaging arm configured for releasably engaging with a portion of a lock pin mechanism, whereby, when the biasing element is freed, the biasing device provides a biasing force to the lock pin mechanism to facilitate release of a lock pin from its place of engagement, the first cylinder extending exteriorly from the first end of the second cylinder as the biasing element extends the shaft from the first cylinder within the interior of the first end of the second cylinder.

10. The biasing device of claim 9, and wherein the dedicated region includes a gripping feature to facilitate contact between the surface and the foot.

11. The biasing device of claim 9, and wherein the engaging arm is contoured to accommodate a curved surface of the lock pin mechanism so as to facilitate the biasing device remaining in place while an operator moves the truck trailer.

12. The biasing device of claim 9, and wherein the biasing element includes a compressed gas.

13. The biasing device of claim 9, and wherein the device further comprises a pliant and insulating gripping material mated to an outer surface of the second cylinder end along a length of the second cylinder sufficient for at least one hand of a user.

14. A tandem axle trailer pin extractor comprising:
a cylinder having a first end and an opposite second end;
a piston slidably mounted in the cylinder;
a shaft secured to the piston and extending out of the first end of the cylinder, the shaft having a distal end, and wherein the piston and shaft are movable between a retracted position in which a substantial portion of the shaft is within the cylinder, and an extended position in which a substantial portion of the shaft is extended out of the cylinder;
a biasing component in the cylinder and configured to operate against the piston thereby providing a biasing force to the piston and shaft;
a trigger configured to hold the piston and shaft in the retracted position until actuated;
a foot mounted to the second end of the cylinder;
an outer cylinder mounted to the distal end of the shaft and concentrically over the cylinder and the shaft, and wherein the outer cylinder includes a first end corresponding to the first end of the cylinder and a second end corresponding to the second end of the cylinder; and
a pair of opposing hooks mounted to and extending radially outward from the second end of the outer cylinder, and wherein the extractor is configured to provide the biasing force between one of the hooks of the outer cylinder and the foot mounted to the cylinder.

15. The device as claimed in claim 14, and wherein the tandem axle trailer pin extractor further comprises a knob mounted to the second end of the outer cylinder, and wherein operation of the trigger is connected with turning of the knob.
